(19) United States
(12) Patent Application Publication
(10) Pub. No.: US 2017/0109486 A1
(43) Pub. Date: Apr. 20, 2017

(54) COMPUTERIZED SYSTEM, DEVICE, METHOD AND PROGRAM PRODUCT FOR MEDICAL TREATMENT AUTOMATION

(71) Applicant: Hien Thanh Tran, Irvine, CA (US)

(72) Inventor: Hien Thanh Tran, Irvine, CA (US)

(21) Appl. No.: 15/193,066

(22) Filed: Jun. 26, 2016

Related U.S. Application Data
(60) Provisional application No. 62/242,307, filed on Oct. 16, 2015.

(51) Int. Cl. G06F 19/00; G06Q 20/18

(52) U.S. Cl. CPC G06F 19/345; G06Q 20/18; G06F 19/3418; G06F 19/3462; G06F 19/325; G06F 19/321; G06F 19/366; G06F 19/322

(57) ABSTRACT

A computerized system and method that automates diagnosing and prescribing treatment plans for patients with medical conditions, such as: dermatological (e.g. acne, dark spots, anti-aging), high blood pressure, diabetes, pre and post-surgical care, pain management, simple infections, and other medical conditions with standardized treatment protocols. The user inputs data comprising symptoms on their mobile device or a kiosk, e.g. a digital photograph of the user's body and/or face made with the computer's camera. The data is analyzed locally or on a remoter server, and an email is returned comprising the diagnosis and treatment plan. If a doctor's approval is required, the server will electronically communicate with a doctor's office computer, and receive the approval, to include authorization for a medical-drug prescription. User medical data input further comprises medical diagnostic equipment and/or laboratory test results that are transmitted to the user's mobile device, kiosk, or directly to the remote server.

### PRIORITY CLAIM

This application claims priority to Provisional U.S. Patent Application Ser. No. 62/242,307 filed Oct. 16, 2015, which is hereby incorporated by reference in its entirety.

### FIELD OF THE INVENTION

The present invention is in the technical field of automation. More particularly, the present invention is in the technical field of medical treatment automation.

### COPYRIGHT NOTICE

A portion of the disclosure of this provisional patent application document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### TRADEMARKS DISCLAIMER

The product names used in this document are for identification purposes only. All trademarks and registered trademarks are the property of their respective owners.

### BACKGROUND OF THE INVENTION

Currently, there are no fully automated commercially available systems that can diagnose and treat patients for medical conditions. The available systems gather information and present them to a physician, who in turn will aggregate the information and synthesize a treatment plan.

### SUMMARY OF THE INVENTION

The present invention comprises a computer system, device, method and program product that automates diagnosing a patient's user's medical condition and prescribing a course of treatment. A computer system analyzes a user's input of their symptoms, such as inputted on a user's electronic computing device (e.g. smartphone with mobile app), or kiosk in a department store, retail store, pharmacy, etc., and wherein the computer accesses the Treatment Automation computer program product of the present invention.

The computer system can also receive: 1) data input from the user (patient) electronic computing device or kiosk computer regarding the user's symptoms, to include a photograph of affected body parts; and/or 2) data input from medical devices (e.g. blood pressure machines, glucose levels, etc.) in communication with the remote computer system, or the user electronic computing device, or the kiosk computer; and/or 3) data input from third party laboratory testing services (e.g. diagnostic lab or doctor's office). This treatment plan can either be directly implemented by the computer system, or it can be reviewed and then approved by a physician prior to implementation, such as when an authorization for a prescription is required.

In an embodiment, the computer system diagnoses a user's medical condition, and determines the optimal course of treatment based on the most up-to-date approved, certified, treatment protocol. The system may also consider the user incurred expenses, and availability of medical treatment products. The treatment plan comprises on or more of: prescription medications; over-the-counter medications (e.g. aspirin, antihistamines, OTC topical steroids or antibiotics, etc.); and non-prescription treatment options-regimes-products (e.g. salicylic acid facial wash, benzoyl peroxide gels, OTC bleaching creams, moisturizers, etc.).

In another embodiment, the user or another entity (e.g. uploaded from doctor office's records) provides the computer system the user's diagnosis, and the computer system determines the optimal course of treatment based on the most up-to-date approved, certified, treatment protocol, user incurred expenses, and availability of medical treatment products.

In an embodiment, the medical conditions comprise one or more of: dermatological conditions, high blood pressure, diabetes, pre and post-surgical care, pain management, simple infections, and any medical condition or procedures with a standardized protocol.

In an embodiment, the medical condition relates to a skin condition selected from one or more of the following: acne, skin discoloration, dark spots, eczema, anti-aging, psoriasis, excessive sweating, rosacea, insect bites, and dry skin. (Check to see if there are other conditions I want added)

The computer system comprises the following computers communicating primarily via a cellular or wireless network: one or more user electronic computing devices (e.g. smartphones with cameras); a remote server with a database of user's records to process a user's input of symptoms and/or medical history, and then determine the optimal course of treatment. The computer system may further comprise the user's doctor office electronic medical record system comprising the user's medical records, recorded diagnosis, and prescription authorization that is sent to the remote server and/or to a pharmacy. And the computer system may further comprise medical diagnostic equipment (e.g. blood pressure, blood glucose, etc.) and/or laboratory testing computers (e.g. with cholesterol levels, complete blood cell count, etc.) transmitting user medical data of conditions to the user device and/or the remote server.

In some geographic locations that the computer system and/or user's mobile device operates in, there is not a legal requirement for a physician to authorize a prescription. Therefore, within these geographical locations, the computer system may further comprise in lieu or in addition to the user's doctor office computer, a pharmacy computer for receiving and filing a user's prescription.

### BRIEF DESCRIPTION OF THE DRAWINGS

FIG. 1 is a flowchart of a fully automated process of the present invention;

FIG. 2 is a flowchart of a hybrid version of the invention of FIG. 1;

FIG. 3A is a block diagram of a system architecture comprising the remote system server communicating with one or more user electronic computing devices, a pharmacy computer, and a doctor's office computer;

FIG. 3B is a block diagram of a user's smartphone with a Treatment Automation Mobile App installed thereon;

FIG. 4A is a flowchart of the computer steps for acne treatment automation;

FIG. 4B is a flowchart of the computer steps for computing the diagnosis (412) and outputting the treatment plan (414) from FIG. 4A;

FIG. 5 is a flowchart of the computer steps for anti-aging treatment automation; and,

FIG. 6 is a flowchart of the computer steps for dark spot treatment automation.

### DETAILED DESCRIPTION OF THE INVENTION

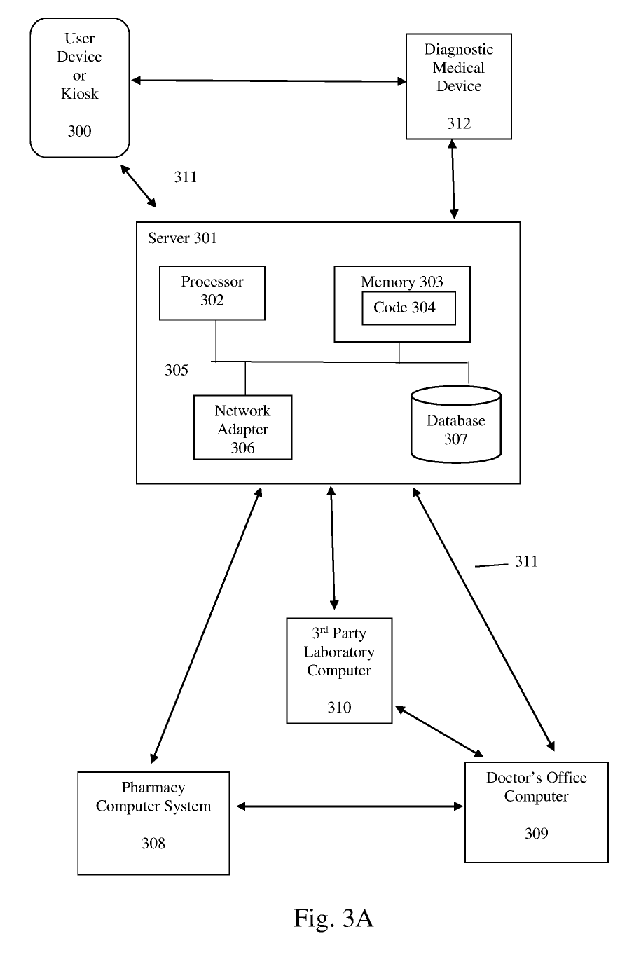

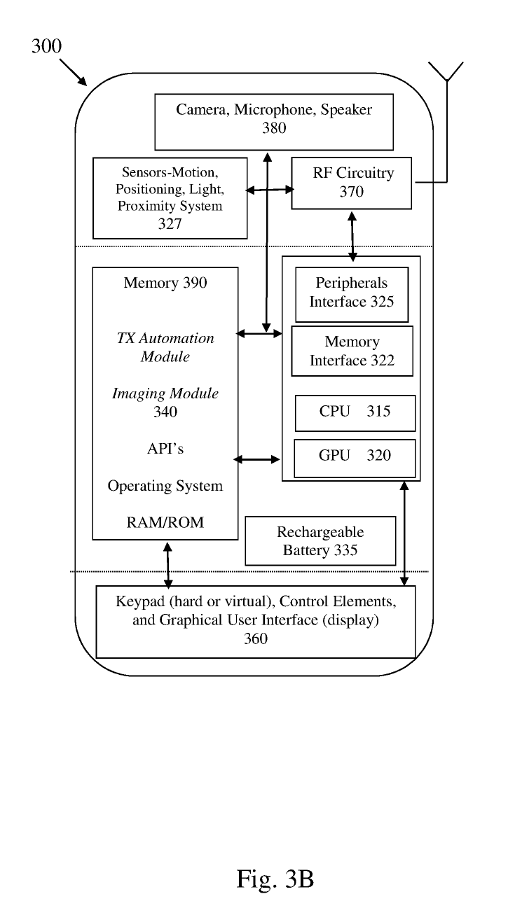

As used herein, the term “Software” or “Computer Program Product” refers to computer program instructions adapted for execution by a hardware element, such as a processor, wherein the instruction comprises commands that when executed cause the processor to perform a corresponding set of commands. The software may be written or coded using a programming language and stored using any type of non-transitory computer- readable media or machine-readable media well known in the art. Examples of software in the present invention comprise any software components, code, modules, programs, applications, computer programs, application programs, system programs, machine programs, and operating system software. The software, or computer program product is installed within memory on a computing device (e.g. FIG. 3A, device 300, or code 304 on Server 301).

As used herein, the term “Electronic Computing Device” refers to any electronic device comprising a central processing unit (i.e. processor) with the ability to transmit and receive electronic communications comprising via Internet and/or cellular connectivity, such as a laptop or desktop computer, a tablet, a smartphone, a personal digital assistance (PDA) device, kiosk, etc.

As used herein, the term “Network” refers to any public network such as the Internet or World Wide Web, or any public or private network as may be developed in the future, which provides a similar service as the present Internet. The users' electronic computing device, and the remote or cloud based system server may connect to the network via a variety of methods such as a phone modem, wireless (cellular, satellite, microwave, infrared, radio, other electromagnetic frequencies, etc.) network, Local Area Network (LAN), Wide Area Network (WAN), or any such means as necessary to communicate to the remote or cloud based server computer that is connected directly or indirectly to the Network.

As used herein, the term “Computerized System” or “Multi-device Computerized System” may be used to claim all aspects of the present disclosure wherein it refers to the entire configuration of hardware and software in all embodiments. In one embodiment, the “system” comprises a user electronic computing device with Internet connectivity. In another embodiment, the system comprises a client-server architecture with a user electronic computing device with Internet connectivity to communicate with a remotely located, or cloud based, system server via a network, wherein the software of the present disclosure is installed on the system server and electronically communicates with the user's device over the network (e.g. the Internet). And/or the user's electronic computing device may have modules (e.g. a mobile app) of the present disclosure installed to communicate with the system server and access the user's online account.

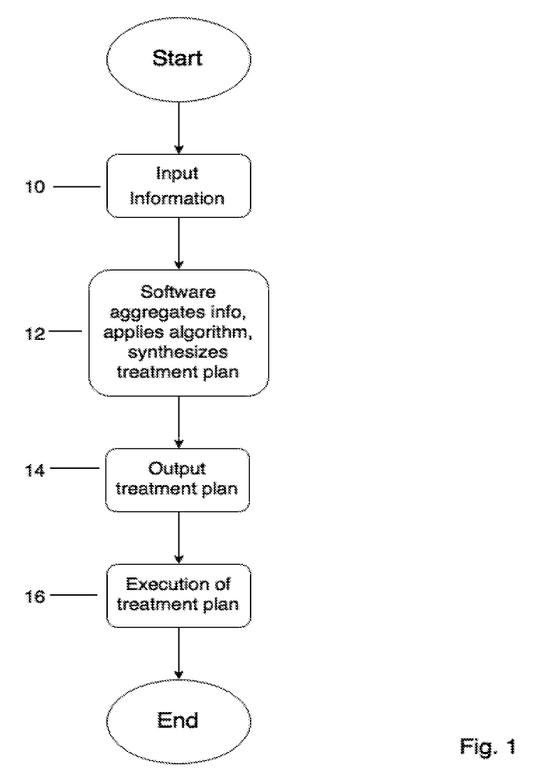

Referring now to the invention in more detail, in FIG. 1 there is shown a flowchart of a computer program product-based automation process which has multiple steps. Each step represents a component required for the functioning of the automation process. Step 10 represents the inputting of information. Step 12 represents the computer program product aggregating the information and applying an algorithm to synthesize a treatment plan. Step 14 represents the computer program product output of the treatment plan based on the aggregated information inputted into the computer program product and the algorithm applied. Step 16 represents the computer program product executing the treatment plan.

In further detail, still referring to the invention of FIG. 1, Step 10, the inputting of information can be done via multiple mechanisms including but not limited to a human user interface device such as but not limited to a laptop, desktop, smartphone, kiosk in a shopping mall, department store, retail store, pharmacy, etc. or any other electronic human user interface device (e.g. FIGS. 3A & 3B, 300), or it can be inputted directly from another electronic or computer program product source such as but not limited to another computer, other medical devices, etc., or it can be inputted from another medical information aggregator such as but not limited to a clinical laboratory, doctor's office, etc. (e.g. FIGS. 3A, 308, 309, 310, 312).

In more detail, still referring to the invention of FIG. 1, Step 12, the algorithm selected can be achieved by multiple mechanisms including but not limited to a human user selection, or it can be automatically selected based on a pre-determined diagnosis, or it can be automatically selected based on the available information inputted in Step 10. Furthermore, the algorithm can be any medically-based algorithm such as but not limited to current best practices and will be utilized by the computer program product to synthesize a treatment plan. The current best practices algorithm can be changed accordingly as new best practices are introduced to supplant the previously established best practices.

In further detail, still referring to the invention of FIG. 1, Step 14, the output of the treatment plan by the computer program product can take multiple forms such as but not limited to a hard copy printout, or it can remain in a digital form for further dissemination via Step 16.

In more detail, still referring to the invention of FIG. 1, Step 16, the computer program product can execute the treatment plan via a number of possible mechanisms including but not limited to communication with the patient, communication with the pharmacist/pharmacy for medications, communication with a physician or support personnel such as but not limited to nursing staff, communications with medical devices in order to execute the treatment plan. Communications can take the form of any electronic communications such as but not limited to text messages, emails, private messaging, etc., and/or voicemails, faxes, other computer program product based communications, and/or direct interaction with end point medical devices that provides medical treatment in order to execute the treatment plan.

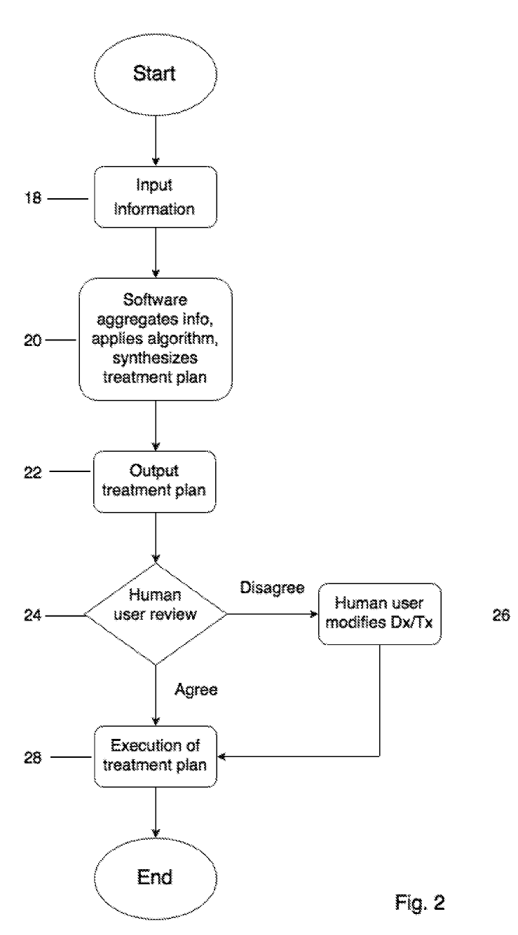

Referring now to FIG. 2, there is shown a flowchart for a hybrid version of the computer program product-based automation process shown in FIG. 1. Each step represents a component required for the functioning of the automation process. Step 18 represents the inputting of information. Step 20 represents the computer program product aggregating the information and applying an algorithm to synthesize a treatment plan. Step 22 represents the computer program product output of the treatment plan based on the aggregated information inputted into the computer program product and the algorithm applied. Step 24 represents the presentation of the treatment plan output by the computer program product to a human user for oversight and review. If the human user disagrees with the treatment plan, then the human user will have the option to make modifications to the treatment plan and diagnosis in Step 26. If the human user agrees with the treatment plan, then the treatment plan will go to Step 28 where it will be executed. Similarly, from Step 26, once the treatment plan has been modified by the human user, the treatment plan will then go to Step 28 where it will be executed.

In further detail, still referring to the invention of FIG. 2, Step 18, the inputting of information can be done via multiple mechanisms including but not limited to a human user interface device such as but not limited to a laptop, desktop, smartphone or any other electronic human user interface device, or it can be inputted directly from another electronic or computer program product source such as but not limited to another computer, other medical devices, etc., or it can be inputted from another medical information aggregator such as but not limited to a clinical laboratory.

In more detail, still referring to the invention of FIG. 2, Step 20, the algorithm selected can be achieved by multiple mechanisms including but not limited to a human user selection, or it can be automatically selected based on a pre-determined diagnosis, or it can be automatically selected based on the available information inputted in Step 18.

Furthermore, the algorithm can be any medically-based algorithm such as but not limited to current best practices and will be utilized by the computer program product to synthesize a treatment plan. The current best practices algorithm can be changed accordingly as new best practices are introduced to supplant the previously established best practices.

In further detail, still referring to the invention of FIG. 2, Step 22, the output of the treatment plan by the computer program product can take multiple forms such as but not limited to a hard copy printout, or it can remain in a digital form for further dissemination via Step 24.

In more detail, still referring to the invention of FIG. 2, Step 24 the presentation of the treatment plan to a human user for oversight or review can take multiple forms including but not limited to a hard copy, or a digital format that is conveyed to the human user via electronic communications such as but not limited to text messages, emails, private messaging, etc., and/or voicemails, faxes, other computer program product based communications. The human user will then review the treatment plan based on the diagnosis and inputted information and will either agree or disagree with the computer program product outputted treatment plan. If the human user disagrees with the outputted treatment plan, then the user will be allowed to modify the treatment plan and, if necessary, the diagnosis in Step 26. If the human user agrees with the outputted treatment plan, then the treatment plan will be submitted for execution by the computer program product in Step 28.

In further detail, still referring to the invention in FIG. 2, Step 26, the human user modifies the computer program product outputted treatment plan and, if necessary, the diagnosis. The modified treatment plan is then submitted for execution by the computer program product in Step 28.

In more detail, still referring to the invention of FIG. 2, Step 28, the computer program product can execute the treatment plan via a number of possible mechanisms including but not limited to communication with the patient, communication with the pharmacist/pharmacy for medications, communication with a physician or support personnel such as but not limited to nursing staff, communications with medical devices in order to execute the treatment plan. Communications can take the form of any electronic communications such as but not limited to text messages, emails, private messaging, etc., and/or voicemails, faxes, other computer program product based communications, and/or direct interaction with end point medical devices that provides medical treatment in order to execute the treatment plan.

In more detail, still referring to the invention of FIG. 2, Step 28, the computer program product can execute the treatment plan via a number of possible mechanisms including but not limited to communication with the patient, communication with the pharmacist/pharmacy for medications, communication with a physician or support personnel such as but not limited to nursing staff, communications with medical devices in order to execute the treatment plan. Communications can take the form of any electronic communications such as but not limited to text messages, emails, private messaging, etc., and/or voicemails, faxes, other computer program product based communications, and/or direct interaction with end point medical devices that provides medical treatment in order to execute the treatment plan.

The advantages of the present invention include, without limitation, an increase in efficiency in treating patients as more patients can be seen and treated autonomously by the computer program product without waiting for a physician. Even with the hybrid version where there is physician oversight, the ability of the computer program product to aggregate all the necessary information and present a treatment plan dramatically decreases the time that a physician would require to evaluate and implement a treatment plan de novo. The computer program product would also increase the speed in the delivery of care as the information inputted would be immediately aggregated and evaluated to synthesize a treatment plan for execution rather than being dependent upon the availability of a physician which may take significantly longer. Furthermore, the computer program product can also improve care as it can be designed to consistently apply established best practices in the treatment plan. Consequently, this computer program product would decrease overall cost and expense in healthcare delivery as it would automate many of the treatments for diagnoses with standardized treatment protocols. Further, it would make it more convenient for many patients to be seen and treated without having to wait too long in an already overburdened healthcare system for an available healthcare provider.

In broad embodiment, the present invention is an autonomous healthcare delivery system.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

### System Architecture

FIG. 3A is a block diagram of an exemplary computer system of the present invention comprising a multi-device computing system that communicates with a plurality of computing devices (300, 301, 308, 309, 310, 312) through a cloud-computing platform comprising a network 311. Server 301 (local or remote), which analyzes the user input to compute the diagnosis and treatment plan, comprises the components: processor 302 that executes the code 304 comprising the computer program product of the present invention; memory 303 which stores the code 304; database 307 that stores one or more doctor's accounts (e.g. Super account holder with a plurality of patient-user medical records) and/or individual patient-user accounts storing inputted data, and outputted diagnoses and treatment plans; a network adapter 306 to connect the server 301 to the network 311 (e.g. the Internet); and a bus 305 that connects the listed computer components.

The multi-device computing system may further comprise one or more doctor office's computers 309 in communication with the server 301 via the network 311. The doctor's computer may receive notifications of diagnosis and treatment plans analyzed by processor 302, and the doctor may transmit back their approval of the plan, or modify the plan.

The multi-device computing system further comprises one or more user electronic computing devices (e.g. FIG. 3A, 300, which is further illustrated in FIG. 3B). The user electronic computing devices 300 comprise central processing unit (i.e. processor 302) with the ability to transmit and receive electronic communications comprising via Internet and/or cellular connectivity using network 311, such as a laptop or desktop computer, a tablet, a smartphone, a personal digital assistance (PDA) device, etc. In an embodiment, the user device 300 further comprises a camera to capture an image of the user.

User devices 300 are in communication with server 301 via the network 311 to input and transmit user data (e.g. symptoms, gender, DOB, etc.), and to take and transmit one or more photographic images using the device's camera (FIG. 3B, 380; or kiosk camera) of the user's afflicted body part or skin. The images may be analyzed on the user device 300 (e.g. FIG. 3B, Imaging Module 340), on the server 301 by the processor 302, or on a third party image analysis computer that forwards the data to the server 301. The network 311 comprises a wireless (cellular, satellite, microwave, infrared, radio, other electromagnetic frequencies, etc.) network when the device 300 is a smartphone, tablet, laptop or desktop computer, kiosk, etc.

The user device 300 may further have installed within memory a mobile app, or computer program product, of the present invention (e.g. FIG. 3B, TX Automation Module 340) that collects and transmits user inputted data and user photographic images to server 301, and works in conjunction with or in lieu of the code 304 to assist the processor 302 in computing a diagnosis and treatment plan.

And as illustrated in FIG. 3B, the user electronic computing device 300 further comprises the following components: memory 390 with an operating system (e.g. Android®); central processing unit 315; graphical processing unit 320; memory interface 322; peripherals interface 325 to facilitate sensor functions 327 (e.g. motion, positioning, light, proximity), camera, microphone and speaker communications 380 to take a digital image of the user's afflicted skin; radio frequency (RF) subsystem 370 to wirelessly transmit user data and images, and to receive emails; and one or more means of inputting user data 360 using a touchscreen or pointer (e.g. keypad- hard or virtual; control elements; GUI; etc.); and a rechargeable battery 335.

Memory 390 has installed therein the treatment (TX) Automation Module and/or the Imaging Module 340 of the present invention, which may further comprise the use of application program interfaces (API' s). The memory 390 or other data storage unit (e.g. FIG. 3A, server database 307) stores the user's data to allow for user feedback on the effectiveness of the treatment plan, which the server 301 or the super-user's computer would be used to compute and implement a modification to the user's subsequent treatment.

Additionally, memory 390 (which may include one or more computer readable storage mediums) also comprises high-speed random access memory and may also include non-volatile memory, such as one or more magnetic disk storage devices, flash memory devices, or other non-volatile solid-state memory devices. Access to memory 390 by other components of the device 300, such as the CPU 315, may be controlled by a memory controller 330.

The RF (radio frequency) subsystem 370 receives and sends RF signals by converting electrical signals to/from electromagnetic signals and communicates with communications networks and other communications devices via the electromagnetic signals. The RF subsystem comprises well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF subsystem communicates with network 311, such as the Internet, an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (Vo1P), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS).

The multi-device computing system may further comprise one or more Pharmacy computer systems 308 for receiving electronic forms of medical prescriptions in accordance to the outputted treatment plan. The prescriptions are transmitted from the doctor's computer system 309 or from the server 301 to the Pharmacy computer system 308; or they are transmitted directly from the server 301 when the user is located within a geographic location that does not legally require a doctor to issue a prescription for medication.

The multi-device computing system may further comprise one or more Third Party Laboratory computers 310 that transmit user diagnostic data to the server 301; and/or to the doctor's computer 309, that stores the data in the user's record on computer 309 while concurrently transmitting it to server 301. Laboratory data may comprise, by way of non-limiting examples, test results for levels of the user blood glucose (to diagnose diabetes, determine the severity of the diabetes, or to monitor the patient's response to treatment), complete blood count (for infections, anemia, etc.), blood cholesterol level (to determine the severity of the disease, and/or to monitor the patient's response to treatment), etc.

The multi-device computing system may further comprise one or more Diagnostic Medical Devices 312 that transmit user diagnostic data via the network 311 to the user device 300 and/or directly to the server 301. The Diagnostic Medical Devices 312 may wirelessly communicate with the user's device 300 (e.g. blood pressure machine synched to smartphone via Bluetooth®; fitness watch; etc.); and/or the user device 300 may further have installed within its memory mobile apps that can analyze the user's physical data.

### EXEMPLIFICATIONS

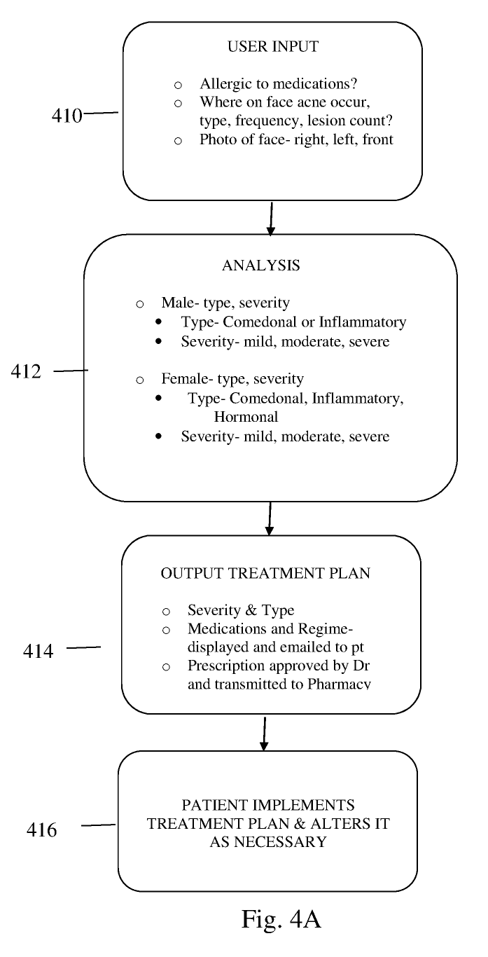

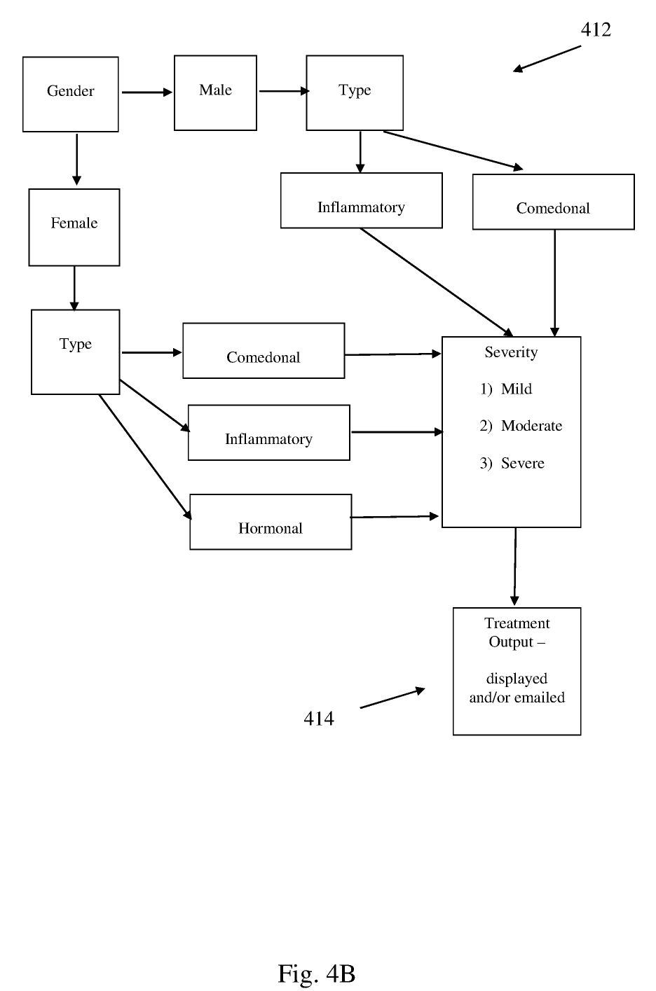

Overview of Flow: As illustrated in the schematic block diagrams of FIGS. 3A, 3B, and the flowchart of computer steps in FIGS. 4A-4B, 5, and 6 the general steps conducted by present invention's computer system for diagnosing and recommending a course of treatment for an acne related skin disorder comprise:
1) Creating a Super-User account on the remote system server 301 by a doctor or retailer that stores a plurality of user-patient data;
2) One or more Users (patients) registering/logging into the computer system via their mobile electronic computing device 300 with the mobile app of the present invention installed thereon or via a website, or via a computer terminal (such as in a mall or drug store kiosk, doctor's office, etc.) and entering their email, date of birth (DOB) and gender;
3) The user/patient inputting (touchscreen, audio response, keystroke response) their response to a series of questions about their medical condition;
4) If an accurate diagnosis and/or treatment of the medical condition requires it, then the usertakes a photo of the afflicted body part (e.g. of face—Right profile, Front view, Left profile);
5) The remote server processor 302 computes and analyzes the user data (from user input, medical history & records stored in user account, etc.) to determine the diagnosis, and treatment plan customized to the user; and
6) Displays on the user device or kiosk 300 (and/or emailing to the user device) the diagnosis and treatment plan.

### Embodiment—Acne Treatment Automation—FIGS. 4A-4B

1) Login
   a. Super-User Login (Doctor's or Store—e.g. Pharmacy, shopping mall kiosk, drug store kiosk, etc.)
      i. Doctor's office computer system 309 (or one or more store kiosks—e.g. a chain of retail stores) registers via a system administrator on the remote system server (FIG. 3A, 301);
      ii. Server 301 will link every account that is logged in on their device or kiosk 300 to their super user account so that the super-user can view the patient's profile.
      iii. If the user-patient logs in to another Super-User account, then the prior Super-User can no longer view their account (e.g. the patient changes doctors). Only the last Super-User account from which the user logs in can access their account.
   b. Register
      i. The User-Patient can sign up and login to the remote server 301 independently from a Super-User as long as they have the mobile App of the present invention installed on their personal device 300 or access to a kiosk computer 300, they can log in.
      ii. The remote server 301 displays: Email address/password
         1. Prompt: “Please provide a valid email address as your treatment plan will be directly emailed to you.”
      iii. Date of Birth
         1. Prompt: “Please provide your real date of birth as this will help us determine if you have teenage or adult acne.”
      iv. Gender—Male/Female
   c. Email is login if user wants to follow up with their treatment.
   d. Once registered, re-direct to the Patient Input.
2) Per FIG. 4A, step 410: The User-Patient Inputs a response to a Series of Question Prompts transmitted to and displayed on the user device or kiosk 300.
   a. Allergy:
      i. Question: “Are you allergic to any of the following medications?”
      ii. Answer options: (Multiple selection possible)
         1. Sulfa based medications
         2. Minocycline/doxycycline/tetracycline
         3. Penicillin/cephalexin
   b. Location:
      i. Question: “Where does your acne tend to occur?”
      ii. Answer options: (Multiple selection possible)
         1. Forehead
         2. Cheeks and Nose
         3. Chin and Jawline
         4. Back and Chest
   c. Type:
      i. Question: “What form does your acne take on most of the time?”
      ii. Answer options: (Single selection only, have example images next to choices)
         1. White pustules
         2. Blackheads
         3. Red bumps on skin surface
         4. Deeps cysts under the skin
   d. Frequency: (Female Only)
      i. Question: “How often does your acne worsen?”
      ii. Answer options: (Single selection only)
         1. Comes and goes
         2. Flares with menstrual cycle
         3. Always present
   e. Lesion Count (Severity of Acne):
      i. Question: “In a typical outbreak, how many pimples do you get?”
      ii. Answer options: (Single selection only)
         1. 1-10 pimples
         2. 11-25 pimples
         3. More than 25 pimples
3) Photo of Face
   a. The mobile App installed on the user device 300, or on the kiosk computer 300, utilizes the device's or computer's camera to take one or more photographs of the user's face (right, left, front).
   b. The device-kiosk 300 displays an example of each photo before taking a photo.
   c. Photograph taking should have an outline of where the face should be (similar to passport photo apps) so that the Patient adjusts the distance to the user device's camera to frame the picture correctly, or the kiosk indicates where the user should stand or sit when the image is taken.
      i. Device-kiosk 300 shows an example of Right profile in outline frame
      ii. Take picture of Right profile
      iii. Device 300 shows an example of Front View in outline frame
      iv. Take picture of Front View
      v. Device 300 shows an example of Left profile in outline frame
      vi. Take picture of Left profile
4) Per FIGS. 4A and 4B, step 412, the remote server 301 conducts an Algorithmic Analysis—Diagnosis that comprises stratifying a pre-determined diagnosis (e.g. acne) into its subcategory (e.g., comedonal acne, inflammatory acne, hormonal acne).
   a. “Your skin is being analyzed.”
      i. User device-kiosk 300 displays an animated graphic depicting analysis.
      ii. Computer has a 10-15 s wait time delay to represent analysis accompanied with the animated graphic depicting analysis.
   b. Computes diagnosis based on severity and gender (Male or Female) (see FIG. 4B)
      i. Male
         1. Type of Acne: Comedonal or Inflammatory
            a. If Type=Pustules/Blackheads, then Comedonal
            b. If Type=Red bumps/Deep cysts, then Inflammatory
         2. Severity of Acne: Mild, Moderate, Severe
            a. If Lesion Count=1-10, then Mild
            b. If Lesion Count=11-25, then Moderate
            c. If Lesion Count=Greater than 25 and/or Type=Deep Cysts, then Severe
      ii. Female
         1. Type of Acne: Comedonal or Inflammatory or Hormonal
            a. If Type=Pustules/Blackheads, then Comedonal
            b. If Type=Red bumps/Deep cysts, then Inflammatory or Hormonal
            c. Inflammatory or Hormonal
            i. If Location=Chin and Jawline, then Hormonal and/or If Frequency=Flares with menstrual cycle, then Hormonal
            ii. All other Location/Frequency selection=Inflammatory
         2. Severity of Acne: Mild, Moderate, Severe
            a. If Lesion Count=1-10, then Mild
            b. If Lesion Count=11-25, then Moderate
            c. If Lesion Count=Greater than 25 and/or Type=Deep Cysts, then Severe
5) Per FIGS. 4A and 4B, step 414, the remote server transmits and displays the diagnosis subcategory of a pre-determined diagnosis) and a treatment plan specific to the user: Algorithm Output
   a. “You have [Diagnosis=Severity of Acne, Type of Acne]”
   b. “You will need the following acne treatment medications: [Treatment listed in separate bullets below this statement]”
   c. “Your treatment plan and directions on how to use your acne medications will be emailed directly to you.”
   d. Treatment:
      i. Each Diagnosis has a pre-determined treatment regimen with minor variations (see iv. Treatment Alternatives). (See Table 1—infra)
      ii. Per FIG. 4, step 416, the User implements treatment plan. The remote server 301 database is updated with new medically approved regimens (e.g. US Food and Drug Administration authorized) comprising new diagnoses, new marketed medications and new treatment regimens-protocols, and the user's treatment plan is changed accordingly (and/or when the user reports a lack of efficacy or adverse reaction to treatment).
      iii. Comedonal Acne
         1. Mild—Treatment Regimen 1
         2. Moderate—Treatment Regimen 2
         3. Severe—Treatment Regimen 3
      iv. Inflammatory Acne
         1. Mild—Treatment Regimen 4
         2. Moderate—Treatment Regimen 5
         3. Severe—Treatment Regimen 6
      v. Hormonal Acne (Female Only)
         1. Mild—Treatment Regimen 7
         2. Moderate—Treatment Regimen 8
         3. Severe—Treatment Regimen 9
      vi. Treatment Alternatives
         1. If Location=Back and Chest, then switch medications with appropriate alternatives listed in the protocol;
         2. If Allergy=Mino/Doxy/TCN, then replace with an appropriate alternative listed in the protocol
         3. If Allergy=Sulfa, then replace with an appropriate alternative listed in the protocol
         4. If Allergy=Sulfa AND Mino/Doxy/TCN, then replace with an appropriate alternative listed in the protocol
         5. If Allergy=ALL, then no oral medications; topical only
   e. Treatment Plan
      i. Is displayed on the user device 301 and/or emailed to the patient directly after the Output is displayed on the screen.
      ii. General set of skin care instructions followed by specific instructions for each medication.

TABLE 1

| | Severity of Acne | | |
|---|---|---|---|
| Type of Acne | Mild | Moderate | Severe |
| Comedonal | Regimen 1 | Regimen 2 | Regimen 3 |
| Inflammatory | Regimen 4 | Regimen 5 | Regimen 6 |
| Hormonal | Regimen 7 | Regimen 8 | Regimen 9 |

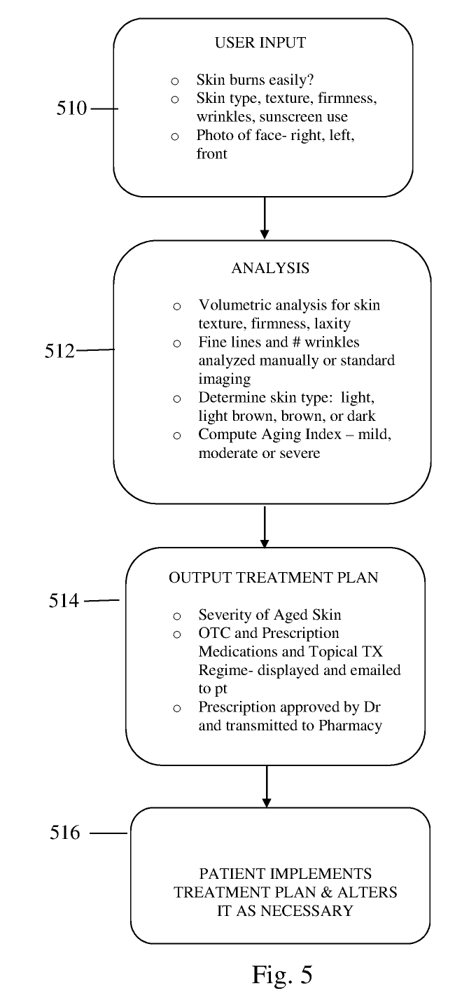

### Embodiment—Anti-Aging Treatment Automation—FIG. 5

1) As illustrated in FIG. 5, step 510, the User-Patient inputs into their user device 300, or the kiosk 300 display, their response to a Series of Question Prompts:
   a. Skin type
      i. Question: “Which best describes your skin in the sun?”
      ii. Answer options:
         1. I burn easily and do not tan
         2. I turn pink and only tan slightly
         3. I do not burn and tan very easily
         4. I never burn because my skin is naturally dark
   b. Texture (5 pts max)
      i. Question: “How dry and rough is your skin?”
      ii. Answer options:
         1. Not dry or rough (1 pt.)
         2. Somewhat dry or rough (3 pt.)
         3. Very dry or rough (5 pt.)
   c. Firmness/Laxity (5 pts max)
      i. Question: “How firm or tight is your skin?”
      ii. Answer options:
         1. Firm and tight (1 pt)
         2. Somewhat firm and tight (3 pt)
         3. Skin is loose and somewhat sagging (5 pt)
   d. Wrinkles (6 pts max)
      i. Question: “Where are your wrinkles located?”
      ii. Answer options (Multiple selection possible):
         1. Around the eyes (2 pt)
         2. Around the mouth (2 pt)
         3. Forehead (1 pt.)
         4. Other areas of face (1 pt.)
   e. Exposure (Risk of worsening or poor treatment response)
      i. Question: “Do you wear sunscreen?”
      ii. Answer options:
         1. Yes
         2. No
2) Photo of face
   a. The mobile App installed on the user device 300 utilizes the device's camera, or the kiosk 300 computer camera, to take photographs of the user's afflicted skin.
   b. The device-kiosk 300 display shows an example of each photograph before user takes a self- photo.
   c. The photograph taking should have an outline of where the face should be (similar to passport photo apps well known in the art:) so that the Patient adjusts the distance to the user device's camera to frame the picture correctly, or the kiosk indicates where the user should stand or sit when the image is taken.
      i. Show example of Right profile in outline frame
      ii. Take picture of Right profile
      iii. Show example of Front View in outline frame
      iv. Take picture of Front View
      v. Show example of Left profile in outline frame
      vi. Take picture of Left profile
3) Per computer step 512, FIG. 5, Image Analysis is performed.
   a. The skin texture and skin firmness and laxity are analyzed using standard imaging computer program product well known in the art using volumetric analyses among other analytic techniques; and/or the image analysis is incorporated into the computer code 304 on the remote server 301.
   b. The fine lines and wrinkles are automatically delineated and analyzed using standard imaging computer program product
      i. Alternatively, the user can manually delineate the fine lines on the image they have taken.
   c. The number of wrinkles are counted (manually or automated).
   d. The skin texture, firmness, and wrinkles are given a score by the remote computer processor 302 ranging from 1-15 each and the combined score represents their aging index (a measure of their skin aging).
      i. 1-5=Mild
      ii. 6-10=Moderate
      iii. 11-15=Severe
4) And further in step 512, FIG. 5, the Algorithmic Analysis comprises:
   a. “Your skin is being analyzed.”
      i. The user device-kiosk 300 displays an animated graphic depicting analysis.
      ii. There is a 10-15 s wait time delay to represent analysis accompanied with the animated graphic depicting analysis.
   b. Computer processor 302 determines the user's Skin Type: Light vs Light Brown vs Brown vs Dark
      i. If Skin type=Burn easily/do not tan, then Light
      ii. If Skin type=Turn pink/tan slightly, then Light Brown
      iii. If Skin type=Do not burn/tan easily, then Brown
      iv. If Skin type=Never burn/naturally dark, then Dark
   c. Computer processor 302 determines the user's Severity of Aging (via Analysis of Question prompts AND/OR Image Analysis, and as a function of the user's skin type, number of wrinkles, skin texture and skin firmness and laxity):
      i. 1-5 points=Mild
      ii. 6-10 points=Moderate
      iii. 11-16 points=Severe
5) Per step 514, FIG. 5, the Algorithm output is displayed on the user device-kiosk 300 and/or is sent via email:
   a. “You have [Severity=mildly, moderately, severely] aged skin”
   b. “Your skin condition needs you to practice strict sun protection if you desire to see improvement.”
      i. If Exposure=Yes, then “Please continue to use your sunscreen, but remember to re-apply every time you go outdoors, and to re-apply every 2 hours if you remain outdoors.
      ii. If Exposure=No, then “You need to start using sunscreen and sun protection, otherwise the treatment that we will start will not be effective and may not improve your skin condition.”
      c. “You will need the following anti-aging treatment medications: [Treatment listed in separate bullets below this statement]”
   d. “Your treatment plan and directions on how to use your anti-aging treatment will be emailed directly to you.”
   e. Treatment:
      i. Each Diagnosis has a pre-determined treatment regimen
      ii. Mildly aged skin
         1. Topical regimen 1
      iii. Moderately aged skin
         1. Topical regimen 2
      iv. Severely aged skin
         1. Topical regimen 3
   f. Treatment Plan
      i. Is emailed to the patient directly after the Output is displayed on the screen.
      ii. General set of skin care instructions followed by specific instructions for each medication.
      iii. Per FIG. 5, step 516, the user implements the treatment plan. The remote server 301 database is updated with new medically approved regimens (e.g. US Food and Drug Administration authorized) comprising new diagnoses, new marketed medications and new treatment regimens-protocols, and the user's treatment plan is changed accordingly (and/or when the user reports a lack of efficacy or adverse reaction to treatment).

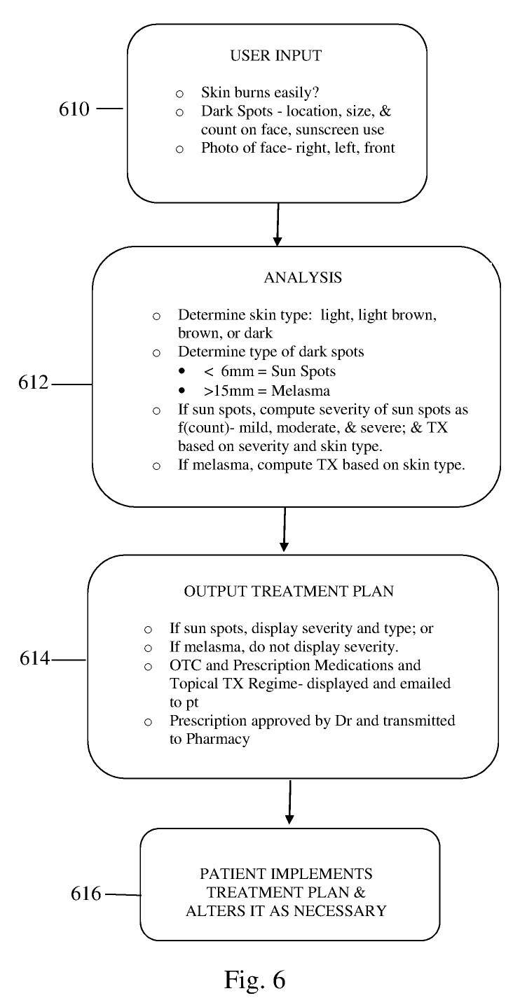

### Embodiment—Dark Spot Treatment Automation—FIG. 6

1) As illustrated in FIG. 6, step 610, the Patient Inputs into their electronic computing device or kiosk computer 300 their response to a Series of Question Prompts, comprising:
   a. Skin type
      i. Question: “Which best describes your skin in the sun?”
      ii. Answer options:
         1. I burn easily and do not tan
         2. I turn pink and only tan slightly
         3. I do not burn and tan very easily
         4. I never burn because my skin is naturally dark
   b. Location
      i. Question: “Where are your dark spots located on your face?”
      ii. Answer options:
         1. Cheeks
         2. Forehead
         3. The remainder of the face
   c. Lesion Size (Differentiates between melasma vs sun spots):
      i. Question: “How large are the dark spots?”
      ii. Answer options:
         1. Less than 6 mm (smaller than a pencil eraser)
         2. Between 6 mm to 15 mm
         3. Larger than 15 mm
   d. Lesion Count (Determines severity):
      i. Question: “How many dark spots do you have?”
      ii. Answer options:
         1. 1-5 spots
         2. 6-15 spots
         3. Greater than 15
   e. Exposure (Risk of worsening or poor treatment response)
      i. Question: “Do you wear sunscreen?”
      ii. Answer options:
         1. Yes
         2. No
2) Photo of face
   a. The mobile App installed on the user device 300 utilizes the device's or kiosk's camera (FIG. 3B, 380) to take a photograph of the user's afflicted skin.
   b. Device-kiosk 300 first displays an example of each photograph before taking it.
   c. Photograph taking should have an outline of where the face should be (similar to passport photo apps well known in the art) so that the Patient adjusts the distance to the user device's camera to frame the picture correctly, or the kiosk indicates where the user should stand or sit when the image is taken.
      i. Show example of Right profile in outline frame
      ii. Take picture of Right profile
      iii. Show example of Front View in outline frame
      iv. Take picture of Front View
      v. Show example of Left profile in outline frame
      vi. Take picture of Left profile
3) Per FIG. 6, step 612, the remote server processor 302, or the user's CPU 315 (FIG. 3B) conducts an Image Analysis of the photographs.
   a. The dark spots on the face are circumscribed using standard image computer program product
      i. Alternatively, the user can manually circumscribe the dark spots on the image they have taken.
   b. The number of circumscribed dark spots are counted
      i. If Lesion count=1-5, then Mild
      ii. If Lesion count=6-15, then Moderate
      iii. If Lesion count greater than 15, then Severe
   c. The average area within the circumscribed dark spots is calculated
      i. If Average area is less than X, then Type=sun spots
      ii. If Average area is greater than Y, then Type=melasma
4) Further per FIG. 6, step 612, the remote server processor 302 executes the Algorithmic Analysis
   a. “Your skin is being analyzed.”
      i. User device-kiosk 300 displays an animated graphic depicting analysis.
      ii. There is a 10-15 s wait time delay to represent analysis accompanied with the animated graphic depicting analysis.
   b. Skin Type: Light vs Light Brown vs Brown vs Dark
      i. If Skin type=Burn easily/do not tan, then Light
      ii. If Skin type=Turn pink/tan slightly, then Light Brown
      iii. If Skin type=Do not burn/tan easily, then Brown
      iv. If Skin type=Never burn/naturally dark, then Dark
   c. Type of Dark spots: melasma vs sun spots
      i. If size=Less than 6 mm, then sun spots;
         1. alternatively, if calculated average area from image is less than X, then sunspots
      ii. If size=Larger than 15 mm, then melasma
         1. Alternatively, if calculated average area from image is greater than Y, then melasma
   d. Severity of sun spots: Mild, Moderate, Severe
      i. If Lesion count=1-5, then Mild
      ii. If Lesion count=6-15, then Moderate
      iii. If Lesion count=Greater than 15, then Severe
5) Per FIG. 6, step 614, the device-kiosk 300 displays the Algorithm Output:
   a. “You have [Diagnosis=Severity of sun spots, Type] (If Type=melasma, then no Severity)
   b. “Your skin condition needs you to practice strict sun protection if you desire to see improvement.”
      i. If Exposure=Yes, then “Please continue to use your sunscreen, but remember to re-apply every time you go outdoors, and to re-apply every 2 hours if you remain outdoors.
      ii. If Exposure=No, then “You need to start using sunscreen and sun protection, otherwise the treatment that we will start will not be effective and may not improve your skin condition.”
   c. “You will need the following dark spot treatment medications: [Treatment listed in separate bullets below this statement]”
   d. “Your treatment plan and directions on how to use your dark spot treatment will be emailed directly to you.”
   e. Treatment:
      i. Each Diagnosis has a pre-determined treatment regimen.
      ii. Skin type=Light/Light Brown
         1. Melasma
            a. Topical Regimen 1
         2. Mild sun spots
            a. Topical Regimen 3
         3. Moderate sun spots
            a. Topical Regimen 4
         4. Severe sun spots
            a. Topical Regimen 5
      iii. Skin type=Brown/Dark
         1. Melasma
            a. Topical Regimen 2
         2. Mild sun spots
            a. Topical regimen 6
         3. Moderate sun spots
            a. Topical regimen 7
         4. Severe sunspots
            a. Topical regimen 8
   f. Treatment Plan
      i. Is emailed to the patient directly after the Output is displayed on the screen; and/or displayed on the user device 300 directly.
      ii. General set of skin care instructions followed by specific instructions for each medication.
      iii. Per FIG. 6, step 616, the user implements the treatment plan. The remote server 301 database is updated with new medically approved regimens (e.g. US Food and Drug Administration authorized) comprising new diagnoses, new marketed medications and new treatment regimens-protocols, and the user's treatment plan is changed accordingly (and/or when the user reports a lack of efficacy or adverse reaction to treatment).

### CONCLUSION

The techniques introduced herein can be implemented by, for example, programmable circuitry (e.g., one or more microprocessors) programmed with software and/or firmware, or entirely in special-purpose hardwired circuitry, or in a combination of such forms. Software or firmware for use in implementing the techniques introduced here may be stored on a machine-readable storage medium and may be executed by one or more general-purpose or special-purpose programmable microprocessors.

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

The various embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

A “non-transitory machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non- recordable media (e.g., read-only memory (ROM) chip; random access memory (RAM) device; magnetic disk storage media; optical storage media; flash memory devices; etc.), etc .

One or more features or steps of the disclosed embodiments can be implemented using an Application Programming Interface (API). An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API. In some implementations, an API call can report to an application the capabilities of a device running the application, such as input capability, output capability, processing capability, power capability, communications capability, etc.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions .

It is to be understood that the phraseology and terminology employed herein is not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

What is claimed is:

1. A computerized method performed by a multi-device computing system, which communicates with a plurality of client devices through a cloud-computing platform, the method comprising:
receiving by a remote computer server a user data input from a user electronic computing device or kiosk computer, wherein the user is a patient and the data comprises answers to system questions regarding a plurality of user symptoms of a medical condition;
analyzing by a remote computer server the data to determine a user diagnosis, and a treatment plan customized to the user;
transmitting the diagnosis and treatment plan to the user electronic computing device or kiosk computer; and
wherein the treatment plan comprises at least one of: a prescription medication; an over-the-counter medication; a non-prescription treatment product; or any combination thereof.

2. The computerized method of claim 1, wherein the method further comprises receiving user input comprising a user modification of the treatment plan.

3. The computerized method of claim 1, wherein the user data input further comprises a digital photograph of an afflicted area of the user body.

4. The computerized method of claim 1, wherein method further comprises transmitting the diagnosis and treatment plan to a doctor of the user, and receiving authorization for a medical prescription indicated by the treatment plan.

5. The computerized method of claim 1, wherein the medical condition comprises one or more of a: dermatological conditions, high blood pressure, diabetes, pre and post-surgical care, pain management, simple infections, and other medical conditions with standardized treatment protocols.

6. The computerized method of claim 5, wherein the dermatological conditions comprises one or more of: acne, dark spots, anti-aging, skin discoloration, eczema, psoriasis, excessive sweating, rosacea, insect bites, and dry skin.

7. The computerized method of claim 1, wherein the data input further comprises a user data from a diagnostic medical device computer in communication with the remote computer server or the user electronic computing device.

8. The computerized method of claim 1, wherein the data input further comprises a user data from a third party laboratory testing services computer.

9. A multi-device computing system, which communicates with a plurality of client devices through a cloud-computing platform, the system comprising:
a remote system server for analyzing a plurality of user medical data comprising a user's symptoms, and determining a medical diagnosis and a treatment plan;
one or more user electronic computing devices or kiosk computers, wherein a user inputs medical data comprising answers to a remote system server questions regarding a plurality of user symptoms of a medical condition;
a network for transmitting user input to the remote system server, and receiving the diagnosis and treatment plan via electronic communications; and
wherein the treatment plan comprises at least one of: a prescription medication; an over-the-counter medication; a non-prescription treatment product; or any combination thereof.

10. The multi-device computing system of claim 9, wherein the user data input further comprises a digital photograph of an afflicted area of the user body.

11. The multi-device computing system of claim 9, further comprising a doctor computing device for transmitting the diagnosis and treatment plan to a doctor for approval.

12. The multi-device computing system of claim 9, wherein the doctor approval further comprises authorizing a medical prescription indicated by the treatment plan.

13. The multi-device computing system of claim 9, further comprising a pharmacy computing device for receiving the medical prescription from the doctor computing device or from the remote system server.

14. The multi-device computing system of claim 9, further comprising a diagnostic medical device computer in communication with the remote system server or the user electronic computing device.

15. The multi-device computing system of claim 9, wherein the medical condition comprises one or more of a: dermatological conditions, high blood pressure, diabetes, pre and post-surgical care, pain management, simple infections, and other medical conditions with standardized treatment protocols.

16. The multi-device computing system of claim 15, wherein the dermatological condition comprises one or more of: acne, dark spots, anti-aging, skin discoloration, eczema, psoriasis, excessive sweating, rosacea, insect bites, and dry skin.

17. A non-transitory machine-readable storage medium having stored thereon a set of instructions which when executed causes the computing device to perform a method comprising automatedly diagnosing a user medical condition and determining a treatment plan, the method comprising,
receiving a user data input comprising answers to a computer system questions regarding a plurality of user symptoms of a medical condition;
analyzing by a processor of a computing device the data to determine a user diagnosis, and a treatment plan customized to the user;
transmitting the diagnosis and treatment plan to the user electronic computing device;
wherein the medical condition comprises one or more of a: dermatological condition, high blood pressure, diabetes, pre and post-surgical care, pain management, simple infections, and other medical conditions with standardized treatment protocols; and
wherein the treatment plan comprises at least one of: a prescription medication; an over-the-counter medication; a non-prescription treatment product; or any combination thereof.

18. A non-transitory machine-readable storage medium of claim 17, further comprising receiving user input comprising a user modification of the treatment plan.

19. A non-transitory machine-readable storage medium of claim 17, wherein the user data input further comprises a digital photograph of an afflicted area of the user body.

20. A non-transitory machine-readable storage medium of claim 17, wherein the method further comprises transmitting the diagnosis and treatment plan to a doctor of the user, and receiving authorization for a medical prescription indicated by the treatment plan.

21. A non-transitory machine-readable storage medium of claim 17, wherein the dermatological condition comprises one or more of: acne, dark spots, anti-aging, skin discoloration, eczema, psoriasis, excessive sweating, rosacea, insect bites, and dry skin.
